(19) United States
(12) Patent Application Publication
(10) Pub. No.: US 2008/0093976 A1
(43) Pub. Date: Apr. 24, 2008

(54) Light-Emitting Device

(75) Inventors: Lucas Johannes Anna Maria Beckers, Eindhoven (NL); Cornelis Gerardus Visser, Eindhoven (NL); Godefridus Johannes Verhoeckx, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,499

(22) PCT Filed: Sep. 14, 2005
(86) PCT No.: PCT/IB05/53022

§ 371 Date: Mar. 19, 2007

(30) Foreign Application Priority Data
Sep. 23, 2004 (EP) 04104632.7

(51) Int. Cl. H01J 1/62; H01J 9/00

(52) U.S. Cl. 313/498; 445/1

(57) ABSTRACT

A light-emitting device comprising a light sources, which emits light, and a first material, located to receive at least a portion of said light is disclosed. The first material comprises a ceramic material, and a contact layer is arranged on said light source to connect said light source to said first material. A method for manufacturing such a device is also disclosed.

### TECHNICAL FIELD

The present invention relates to a light-emitting device comprising a light source, which emits light, and a first material, located to receive at least a portion of said light.

### TECHNICAL BACKGROUND

Semiconductor light-emitting devices, such as light-emitting diodes (LEDs) and laser diodes (LDs), are among the most efficient and robust light sources currently available.

Light extraction is one of the key issues in high-power inorganic LEDs for lighting applications. A common problem with conventional semiconductor light-emitting devices is that the efficiency with which light may be extracted from such a device is reduced by total internal reflection at interfaces between the device and the surrounding environment, followed by reabsorption of the reflected light in the device. Such total internal reflection occurs because the index of refraction (n_{d}) of the semiconductor materials from which the device is formed at the emission wavelengths of the device is larger than the index of refraction of the material, typically epoxy or silicone, in which the device is packaged or encapsulated. Drawbacks of these encapsulating materials are thus the limited n_{d} match, and also limitations of durability against high temperature and photon density.

Losses due to total internal reflection increase rapidly with the ratio of the refractive index inside the device to that outside the device. For example, the high n_{d} of sapphire (Al₂O₃) LED material strongly limits the amount of light transmitted into air.

Phosphors are used in semiconductor light-emitting devices in order to broaden or shift the emission spectrum of the semiconductor light-emitting devices. This approach involves using the emission of a semiconductor light-emitting device to excite a phosphor.

EP 1 369 935 addresses the problem of reduced light extraction in semiconductor light-emitting devices, and proposes a semiconductor light-emitting device utilising phosphor particles with reduced size. Thereby, the scattering by phosphor particles, which decreases the efficiency of conventional phosphor converted light-emitting devices, is reduced, and the light extraction is improved.

In EP 1 369 935, it is also suggested that the light scattering by phosphor particles is reduced by increasing the refractive index of the medium in which they are embedded to more closely match the refractive index of the phosphor particles.

One disadvantage of the solution suggested in EP 1 369 935 is that the medium in which the phosphor particle are embedded has to be in contact with the sapphire of the light-emitting device. Therefore, high process temperatures could damage the n/p layers of the LED.

Further, at higher temperatures, i.e. above 200° C., the thermal expansion of the medium including the phosphor is very important. In EP 1 369 935, the epoxies, acrylic polymers, polycarbonates and silicone polymers will not survive temperatures above 150° C. for a long period. In the case of high power LEDs, where the temperature of the operating LED can raise up to 250° C., all the organic media mentioned in EP 1 369 935 are failing, because they will burn out in the application for high power LED (5 Watt per square mm per chip).

Therefore, there is a need for obtaining new light-emitting devices, which are less sensitive to high process temperatures and which have improved light extraction characteristics.

### SUMMARY OF THE INVENTION

An object with the present invention is to obtain light-emitting devices being less sensitive to high process temperatures, and having improved light extraction

This object is achieved by a light-emitting device comprising a light source, which emits light, and

a first material, located to receive at least a portion of said light, wherein said first material comprises a ceramic material, and wherein a contact layer is arranged on said light source to connect said light source to said first material.

The contact layer may be made from chalcogenide glass, and its thickness may be in the range of 2 to 3 microns.

The use of a contact layer prevents a direct contact between the first material and the light source. Thus, the risk for damages of the light source at high process temperatures is minimized.

Said first material may comprise e.g. polycrystallin alumina (Al₂O₃), yttrium-aluminium-garnet (YAG, Y₃Al₅O₁₂), yttria (Y₂O₃), MgAl₂O₄, MgAlON, aluminum nitride (AlN), AlON, and titania (TiO₂) doped zirconia (ZrO₂), or mixtures thereof, and is arranged on at least a portion of said light source. The first material preferably has a refractive index of greater than 1.75.

The light source may be a light-emitting diode (LED), comprising an inorganic second material having a refractive index of greater than 1.75. For example, the second material may be sapphire (Al₂O₃).

By the present invention, a refractive index match between the light source and the ceramic material arranged to receive the light is obtained. Further, the ceramic material has about the same coefficient of expansion as the light source (i.e. sapphire), and is resistant at operating temperatures up to 250° C. for a very long time. This provides for significantly improved light extraction properties compared to prior art light-emitting devices, and the degradation problems, observed when using organic materials as light receiving materials, are avoided.

A light-emitting device according to the invention may further comprise a luminescent material. The luminescent material may be in the form of particles, i.e. phosphors, which are uniformly dispersed in the first material.

The use of ceramics enables a very uniform distribution of the phosphor particles.

The luminescent material may also be arranged as a layer in said first material, which layer is located to receive at least a portion of said light. The luminescent material may e.g. be YAG:Ce, which converts blue light into white light.

A light-emitting device according to the invention may further comprise a reflective coating, which at least partly encloses said first material.

The invention also relates to a method for manufacturing a light-emitting device, comprising providing a light source, which emits light; arranging a contact layer on said light source; and applying, with a sintering process, a first material, comprising a ceramic material, to receive at least a portion of said light.

The method may further comprise the application of a luminescent material, in the form of uniformly dispersed particles, by co-sintering with said first material. Alternatively, the method further comprises the application of a luminescent material as a layer in said first material, which layer is located to receive at least a portion of said light.

### BRIEF DESCRIPTION OF THE DRAWINGS

FIG. 1 shows a light-emitting device according to the invention, having phosphor particles for light conversion.

FIG. 2 shows a light-emitting device according to the invention, having an incorporated phosphor layer to convert light.

### DETAILED DESCRIPTION OF THE INVENTION

In the research work leading to the present invention, the inventors surprisingly found that light-emitting devices having an extraction body comprising a ceramic material (with high n_{d}), and a contact layer connecting the material of the extraction body and the material of the light source, are less sensitive to high process temperatures. Such devices also have improved light extraction characteristics.

The light-emitting device (1) comprises a first material (2), forming a body. Said first material comprises a ceramic material. Ceramics are materials where crystalline structures are present in the materials in a single crystal form or in a polycrystallin form. Single crystals are grown out of a meld and are grinded in the needed shape. Polycrystallin ceramics are shaped by means of a powder route and sintered for densification.

The first material is suitably transparent, and has a refractive index of greater than 1.75. Alternatively, the first material has a refractive index of greater than 2.2.

Examples of ceramic materials to be used in the body are polycrystallin alumina (Al₂O₃), yttrium-aluminium-gamet (YAG, Y₃Al₅O₁₂), yttria (Y₂O₃), (MgAl₂O₄), MgAlON, aluminum nitride (AlN), AlON, and titania (TiO₂) doped zirconia (ZrO₂). However, any ceramic material guaranteeing a high n_{d} could be used according to the invention. In addition, mixtures of the above-mentioned ceramic materials may be used.

The body receives at least a portion of the light produced by the light source (3) of the device. It is important that the body efficiently extracts the light, and passes it through to the outside. The total light output has to be optimised.

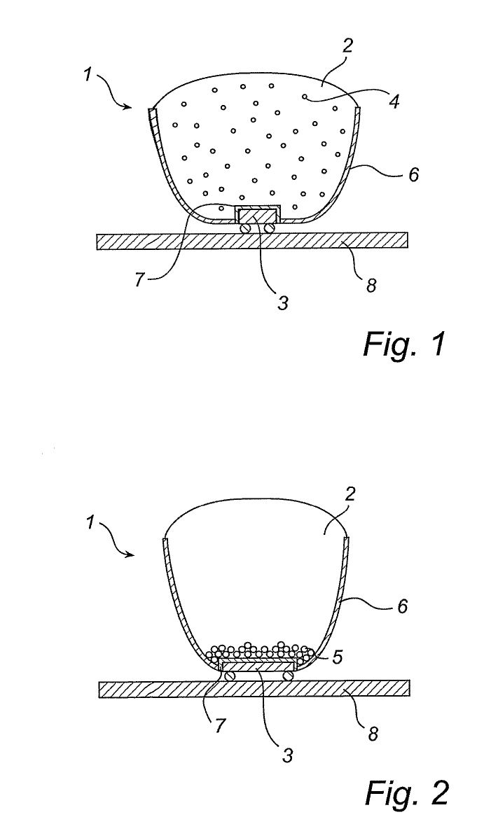

The top of the body is shaped in such a way that the required light emission pattern is produced. An example of a shape to be used for light-emitting devices according to the invention is shown in FIGS. 1 and 2.

A contact layer (7) is arranged on the LED, to connect the LED and the body. Thereby, there is no direct contact between the LED material and the body. The contact layer is preferably a glassy layer, and may e.g. be made from a chalcogenide glass. The contact layer may e.g. have a thickness of approximately 2 to 3 microns. The filter factor of this coloured type of glass (yellow, orange or red) will be very low in case a very thin layer is used.

The body is provided with luminescent materials (i.e. phosphors) for conversion of the light. As used herein, a “luminescent material” refers to a material, which absorbs light of one wavelength and emits light of a different wavelength. One examples of a phosphor to be used in connection with the present invention is YAG:Ce. YAG:Ce relates to yttrium aluminium garnet, or yttriumaluminate (Y₃Al₅O₁₂), doped with Cerium 3+ for phosphor working.

The YAG:Ce-phosphor can be sintered with YAG and alumina without losing its phosphor (luminescent) activity. Consequently, where YAG or alumina is the light extraction body, the mixture of YAG:Ce embedded in the alumina is co-sintered (co-fired). The refractory index of YAG:Ce is almost equal to that of alumina and YAG.

The phosphors may be in the form of particles (4) which are uniformly dispersed in the body. However, other arrangements are also possible, like for example providing a phosphor layer (5) in the body. Integration of phosphors in the body for light extraction causes diffusion of the light, what is qualifying for translucent materials.

The body and the light source is mounted on a substrate (8).

The outside of the body is reflective (specular or diffuse) to collimate. In FIG. 1 and FIG. 2, a reflective layer (6) is integrated, but an external reflector is also a possibility.

The reflective layer (6) is reflecting the light inside the material (2), so it is collecting the light. In case of a diffuse coating (for example an alumina powder layer which is not densified so that it is become white diffusive with a total reflectivity of 99%) the light will be collected. In case of a specular reflective coating (Al or Silver) the light will be reflected.

If the light is reflected specular into medium, which is translucent, then the light will be collimated again. In FIG. 2 the medium is transparent, and the specular reflective layer will function as a real reflector.

The reflective coating (6), or the external reflector, at least partly encloses the body. In this context “at least partly” means that there is no coating at the upper side, to define a light beam, and that there is no coating where the thin glass layer (7) contacts the light extraction body to the sapphire of the light-emitting device (3).

The light source in a light-emitting device according to the invention is preferably a light-emitting diode (LED). However, also laser diodes (LDs) may be used.

The LED comprises an inorganic second material having a refractive index of greater than 1.75. Alternatively, the LED comprises an inorganic material having a refractive index of greater than 2.2. An example of an inorganic second material to be used in the LED is sapphire.

Blue LEDs are constructed by growing n/p light emitting layers (InGaN-based) on sapphire (single crystal alumina) substrates (the “flip chip modification”, which means that the electrode connections are at the lower side of the LED, so no wire bond is present at the upper side).

The refractive index of the LED and the refractive index of the body may be nearly the same. For example, the difference between the refractive index of the LED and the refractive index of the body may be close to zero, or zero. However, for some material combinations, there may be a difference between the refractive indices. A higher refractive index of the body improves collimation.

As used herein, refractive index (n_{d}) refers to
n_{d}=c/(vₚₕₐₛₑ)
where c is the speed of light and vₚₕₐₛₑ is the phase velocity. It gives the amount of refraction which takes place for light passing from one medium to another.

The body may be arranged directly on at least a portion of the light source, i.e. the LED, of the device. For example, the body is arranged on the whole outer surface of the light source. The body can be manufactured by injection moulding and than de-binded and sintered. Beside injection moulding the body can also be made by gelcasting, or slipcasting.

The invention can be applied for every light application where LEDs are used. It is especially well-suited high power LED where the temperature of the operating LED can raise up to 250 C.

A light-emitting device according to the invention may be manufactured by providing a light source, which emits light; arranging a contact layer on said light source; and applying, with a sintering process, a first material, comprising a ceramic material, to receive at least a portion of said light.

The method may further comprise the application of a luminescent material, in the form of uniformly dispersed particles, by co-sintering with said first material. Alternatively, the method further comprises the application of a luminescent material as a layer in said first material, which layer is located to receive at least a portion of said light.

The device may be manufactured by conventional methods, which are well-known for a man skilled in the art.

1. A light-emitting device comprising
a light source, which emits light, and
a first material, located to receive at least a portion of said light,
characterized in that
said first material comprises a ceramic material, and a contact layer is arranged on
said light source to connect said light source to said first material.

2. A light-emitting device according to claim 1, wherein said contact layer has a thickness in the range of 2 to 3 microns.

3. A light-emitting device according to claim 1, wherein said contact layer is made from chalcogenide glass.

4. A light-emitting device according to claim 1, wherein said first material comprises a material selected from the group consisting of polycrystallin alumina (Al₂O₃), yttrium-aluminium-garnet (YAG, Y₃Al₅O₁₂), yttria (Y₂O₃), (MgAl₂O₄), MgAlON, aluminum nitride (AlN), AlON, and titania (TiO₂) doped zirconia (ZrO₂), or mixtures thereof.

5. A light-emitting device according to claim 1, wherein said light source is a light-emitting diode (LED).

6. A light-emitting device according to claim 5, wherein said LED comprises an inorganic second material having a refractive index of greater than 1.75.

7. A light-emitting device according to claim 6, wherein said second material is sapphire.

8. A light-emitting device according to claim 1, further comprising a luminescent material.

9. A light-emitting device according to claim 8, wherein said luminescent material is in the form of particles.

10. A light-emitting device according to claim 9, wherein said particles are uniformly dispersed in said first material.

11. A light-emitting device according to claim 8, wherein said luminescent material is arranged as a layer in said first material, which layer is located to receive at least a portion of said light.

12. A light-emitting device according to claim 8, wherein said luminescent material is YAG:Ce.

13. A light-emitting device according to claim 1, further comprising a reflective coating, which coating at least partly encloses said first material.

14. A method for manufacturing a light-emitting device, comprising
providing a light source, which emits light,
arranging a contact layer on said light source,
applying, with a sintering process, a first material, comprising a ceramic material, to receive at least a portion of said light.

15. A method according to claim 14, further comprising
applying a luminescent material, in the form of uniformly dispersed particles, by co-sintering with said first material.

16. A method according to claim 14, further comprising
applying a luminescent material as a layer in said first material, which layer is located to receive at least a portion of said light.
